(19) United States
(12) Patent Application Publication
(10) Pub. No.: US 2014/0337111 A1
(43) Pub. Date: Nov. 13, 2014

(54) REWARDING ONLINE ADVOCATES

(71) Applicant: International Business Corporation, Armonk, NY (US)

(72) Inventors: Karl J. Cama, Coppell, TX (US); Norbert Herman, Denver, CO (US); Daniel Lambert, Manhattan, NY (US); Vikas R. Pathuri, Fremont, CA (US)

(73) Assignee: International Business Corporation, Armonk, NY (US)

(21) Appl. No.: 13/892,533

(22) Filed: May 13, 2013

(51) Int. Cl. G06Q 30/02

(52) U.S. Cl. CPC G06Q 30/0214
USPC 705/14.16

(57) ABSTRACT

A method and associated systems for rewarding online advocates. The invention identifies a primary advocate as a person or entity that endorses or advocates a product or service. The invention then automatically detects, tracks, and analyzes characteristics of the advocate's act of advocating the product or service to recipients. The invention also tracks the primary advocate's conversions, which occur when the primary advocate's act of advocating influences a recipient into advocating a product or service. The invention then automatically rewards the primary advocate as a function of characteristics of the primary advocate's influence and of the primary advocate's ability to convert recipients.

### TECHNICAL FIELD

The present invention relates to automatically rewarding an advocate of a product or service.

### BACKGROUND

An individual's activity or expression of opinion can influence the actions of online recipients who receive communications as a result of the activity or expression. The cumulative effect of such influence on many online users may in aggregate comprise a significant influence.

Because such a significant influence may further the business or personal goals of a third party, that third party may wish to encourage activities and expressions of opinion that exert a type of influence desired by the third party. One way to do this is to reward influential persons who perform an activity or express an opinion that is more likely to produce a desired type of influence. This rewarding, however, requires a way to identify influential individuals and their activities and expressions and to determine an appropriate manner, type, or quantity of reward or incentive.

### BRIEF SUMMARY

A first embodiment of the present invention provides a method for rewarding online advocates, said method comprising:

a processor of a computer system identifying an entity as a primary advocate, wherein the identifying is a function of an advocacy of the entity, and wherein the advocacy comprises the entity's act of advocating an advocated product or service;

the processor automatically tracking a set of the primary advocate's conversions, wherein a tracked conversion of the set of the primary advocate's conversions comprises a first converted advocate's advocacy, and wherein the first converted advocate's advocacy comprises the first converted advocate's act of advocating the advocated product or service as a function of the primary advocate's advocacy;

the processor determining a reward for the primary advocate as a function of the identification and as a further function of the tracked conversion.

A second embodiment of the present invention provides a computer program product, comprising a computer-readable hardware storage device having a computer-readable program code stored therein, said program code configured to be executed by a processor of a computer system to implement a method for rewarding online advocates, said method comprising:

the processor identifying an entity as a primary advocate, wherein the identifying is a function of an advocacy of the entity, and wherein the advocacy comprises the entity's act of advocating an advocated product or service;

the processor automatically tracking a set of the primary advocate's conversions, wherein a tracked conversion of the set of the primary advocate's conversions comprises a first converted advocate's advocacy, and wherein the first converted advocate's advocacy comprises the first converted advocate's act of advocating the advocated product or service as a function of the primary advocate's advocacy;

the processor determining a reward for the primary advocate as a function of the identification and as a further function of the tracked conversion.

A third embodiment of the present invention provides a computer system comprising a processor, a memory coupled to said processor, and a computer-readable hardware storage device coupled to said processor, said storage device containing program code configured to be run by said processor via the memory to implement a method for rewarding an advocate, said method for rewarding online advocates, said method comprising:

the processor identifying an entity as a primary advocate, wherein the identifying is a function of an advocacy of the entity, and wherein the advocacy comprises the entity's act of advocating an advocated product or service;

the processor automatically tracking a set of the primary advocate's conversions, wherein a tracked conversion of the set of the primary advocate's conversions comprises a first converted advocate's advocacy, and wherein the first converted advocate's advocacy comprises the first converted advocate's act of advocating the advocated product or service as a function of the primary advocate's advocacy;

the processor determining a reward for the primary advocate as a function of the identification and as a further function of the tracked conversion.

### BRIEF DESCRIPTION OF THE DRAWINGS

FIG. 1 shows a structure of a computer system and computer program code that may be used to implement a method for rewarding an advocate in accordance with embodiments of the present invention.

FIG. 2 is a flowchart that overviews embodiments of the present invention that automatically reward or incentivize an advocate of a company's product or service.

FIG. 3 shows an example of a multi-generational advocacy, wherein advocates may be rewarded by iterative applications of the embodiments of FIG. 2.

### DETAILED DESCRIPTION

A user of an electronic, online, or nonelectronic communications medium may use that medium to perform an activity, express an opinion, or communicate other information that may influence an activity or opinion of a recipient online user of the same or a different communications medium. Such communications media may comprise, but are not limited to: a social-media Web site or electronic social-media service; a blog; a public or private computer network or cellular network; other types of public, private, semi-public, or hybrid networks; a broadcast or interactive news, opinion, or information-generation or information-dissemination medium; a publicly accessible, mutually accessible, or other communications device, resource, or platform shared between an acting, expressing, or communicating individual and an online recipient user; or combinations thereof.

In some cases, although an acting, expressing, or communicating individual may perform an activity, express an opinion, or communicate other information via a nonelectronic or a offline medium, a recipient may still perceive or receive the activity, opinion, or other information directly or indirectly through an electronic or online medium. In this document, we will refer to such an individual as acting “online” if the individual's offline or nonelectronic act, expression, or communication has a directly or indirectly perceptible effect in an electronic or online medium or directly or indirectly results in a communication of information that may be perceived through an electronic or online medium.

Many types of activities and expressions of opinion may influence a recipient's activity or expression of opinion or may influence the original acting, expressing, or communicating individual. These types of activities and expressions may include, but are not limited to: posting, reposting, citing, quoting, describing, or forwarding a review, analysis, recommendation, specification, comparison, or other information about a product or service; posting, reposting, citing, quoting, describing, or forwarding opinions, analysis, or other information about a person, a company, a consortium an other type of organization or group, or an other type of entity; describing a first-hand, second-hand, or third-hand experience with a business, product, resource, entity, or service; reinforcing or disagreeing with another entity's communication through a comment, activity, endorsement, repudiation, citation, quoting, or linkage; proposing a solution to an identified problem or proposing a strategy or observation that may help a recipient solve an identified problem; using certain express language or implying certain subtext; selecting entities with which to share communications; and sharing personal information.

When a potentially influencing entity's activity or expressed opinion influences an action or opinion of an online recipient, the number of influenced recipients may range from a single recipient to a very large number of recipients. If many influenced recipients act at least partially in concert or act at least partially in pursuit of related goals, the aggregate activity of those many recipients may be described as a mass collaboration.

The method of the present invention may be most effective in embodiments that comprise larger numbers of influenced recipients, but may be effective even when there are fewer influenced recipients. In some embodiments, a greater degree of influence ascribed to a potentially influencing entity may increase a likelihood that many influenced recipients act at least partially in concert or act at least partially in pursuit of related goals.

A recipient may be self-selected, may be selected randomly or by a mathematical or statistical function, or may be selected directly or indirectly as a function of the recipient's interest in a particular topic, or as a function of the recipient sharing a interest with a potentially influencing entity. In some embodiments, a recipient may be selected as a function of a selection, preference, or characteristic of a potentially influencing entity.

A degree of direct or indirect influence exerted by a potentially influencing entity's online activity or expressed opinion on recipient may range from great influence to immeasurably small or no influence. But even when an influence on a recipient is small, an aggregate effect of a potentially influencing entity's activity or expressed opinion on many recipients may be significant.

Influenced recipients may themselves become influencers by undertaking an online or offline activity or by expressing an opinion in online or offline media. If an activity or expressed opinion of such an influenced recipient has been influenced by an earlier activity or an earlier expressed opinion of an other influencer, the recipient is said to have been “converted” by the other influencer. A converted recipient's activity or expression of opinion may be performed or expressed in an online, electronic, or nonelectronic medium and, in some embodiments, the converted recipient may be considered to have been converted even if the converted recipient's activity or expression of opinion exerts no influence or has no recipients of its own.

In some cases, a primary or first-generation influencer may convert a first generation of recipients, who may in turn convert a second generation of recipients, who may next convert yet another, third, generation of recipients, and this process may continue through an indefinite number of generations. It is thus possible that an individual who communicates directly with a small number of recipients may, over multiple generations of conversions, indirectly influence a great number of online or offline recipients.

Because such influence may further a business or personal goal of a third party, that third party may wish to promote an activity or an expression of opinion that the third party believes will encourage a desired belief, opinion, agenda, or activity. One way to accomplish such promoting is to reward, motivate, or otherwise incentivize influencers who perform an activity or express an opinion that promotes or advocates the desired belief, opinion, agenda, or activity. Such rewarding, motivating, or incentivizing may occur at the time of or at any time after an influencer's influential activity or expression of opinion. In some cases, this rewarding, motivating, or incentivizing may be performed multiple times as a function of a change in a perceived value of an influential activity or expression of opinion.

Embodiments of the present invention may be implemented in fields that include, but are not limited to: marketing, promotion, customer service, product design, problem-solving, production, maintenance, business planning, market development, hiring, fundraising, human resources, and any other area wherein an entity wishes to encourage certain influential activities.

Embodiments of the present invention may also be integrated with conventional techniques, operations, methods, and procedures. A product-marketing effort might, for example, use an embodiment of the present invention to promote favorable opinions about a company blog, wherein the blog had been developed, posted, and otherwise promoted online by means of a conventional online-marketing effort.

Practices like crowdsourcing and mass-collaboration project-development may incorporate embodiments of the present invention that reward or incentivize individuals who voluntarily or involuntarily participate in such efforts. In one example, an electronics manufacturer might use an embodiment of the present invention to reward bloggers who promote a premise that a certain product form factor works best in a particular type of user environment. A customer-support organization might use an embodiment of the present invention to encourage customers to post online messages that describe and promote an end-user workaround that mitigates a product-interface problem. In other cases, a business might use an embodiment of the present invention: to encourage customers to adhere to recommended product-maintenance schedules; to describe to potential employees a benefit of working for the business; or to build anticipation for an impending product launch.

Potentially influencing entitys who participate in such efforts may be rewarded or incentivized in different ways, and such rewarding or incentivizing may comprise providing one or more types of rewards or incentives. An online collaborative marketing service may, for example, pay an individual a small amount of money in return for an activity or expression of opinion that promotes an interest of an advertiser or associate. A subset of voluntary online collaborators may dedicate themselves to online mass-collaboration or “crowdsourcing” work as a primary source of income.

Other individuals may be motivated by non-monetary rewards or incentives, such as: social contact; intellectual stimulation; the enjoyment of participating in an online activity; identification with a particular opinion, community, product, industry, or business; altruistic motives; greater chance of visibility to a celebrity, a prospective employer, or an opinion-maker; avoidance of negative peer pressure; an enhanced feeling of empowerment or self-worth; or greater reputation or prestige within an online or offline community. Some individuals may, for example, experience greater motivation to voluntarily perform a desired task when they perceive that task to be a way of addressing a social problem. In other cases, an influencer may be rewarded with a discount, special offer, coupon, or privilege (such as access to restricted content). In some cases, an incentive may comprise a bartering and, in some embodiments, methods of the present invention may independently or dependently interact to determine and exchange incentives among pairs or groups of advocates.

In one example, a “crowdsourcer” who helps write an online encyclopedia entry as part of a mass-collaboration project may be motivated by a non-monetary incentive that comprises including his name in a “contributor's list” published on a prestigious Web site.

Regardless of the type of reward or incentive that motivates a potentially influencing entity, effectively rewarding or incentivizing that influencer may require a way to identify and characterize the influencer, to identify and characterize the influencer's activities and expressions of opinion, and to determine the manner, type, or quantity of reward appropriate to the activity or expression and to the influencer being rewarded. In some embodiments, this identifying, characterizing, and determining, as well as a choice of a means to provide or deliver a reward or incentive to a potentially influencing entity, may be automated by embodiments of the present invention.

The present invention may accomplish these goals as a method performed by embodiments that comprise a method performed by a processor of a computer system, by a computer program product, by a computer system, or as a processor-performed process or service for supporting computer infrastructure.

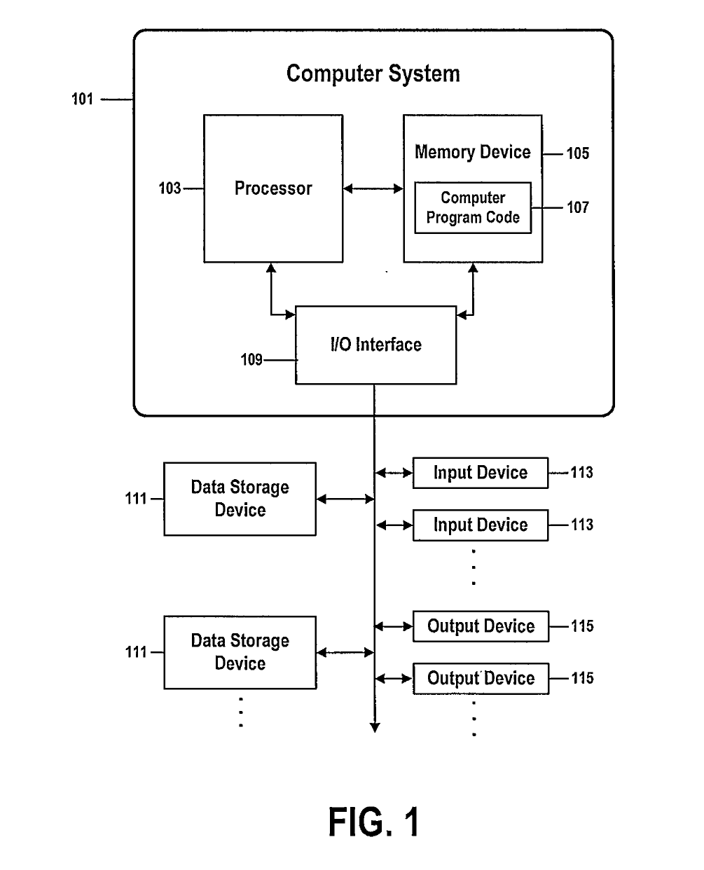

FIG. 1 shows a structure of a computer system and computer program code that may be used to implement a method for rewarding an advocate in accordance with embodiments of the present invention. FIG. 1 refers to objects 101-115.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, in one embodiment, the present invention may take the form of a computer program product comprising one or more physically tangible (e.g., hardware) computer-readable medium(s) or devices having computer-readable program code stored therein, said program code configured to be executed by a processor of a computer system to implement the methods of the present invention. In one embodiment, the physically tangible computer readable medium(s) and/or device(s) (e.g., hardware media and/or devices) that store said program code, said program code implementing methods of the present invention, do not comprise a signal generally, or a transitory signal in particular.

Any combination of one or more computer-readable medium(s) or devices may be used. The computer-readable medium may be a computer-readable signal medium or a computer-readable storage medium. The computer-readable storage medium may be, for example, but is not limited to, an electronic, magnetic, optical, electromagnetic, infrared, or semiconductor system, apparatus, or device, or any suitable combination of the foregoing. More specific examples (a non-exhaustive list) of the computer-readable storage medium or device may include the following: an electrical connection, a portable computer diskette, a hard disk, a random access memory (RAM), a read-only memory (ROM), an erasable programmable read-only memory (EPROM or flash memory), Radio Frequency Identification tag, a portable compact disc read-only memory (CD-ROM), an optical storage device, a magnetic storage device, or any suitable combination of the foregoing. In the context of this document, a computer-readable storage medium may be any physically tangible medium or hardware device that can contain or store a program for use by or in connection with an instruction execution system, apparatus, or device.

A computer-readable signal medium may include a propagated data signal with computer-readable program code embodied therein, for example, a broadcast radio signal or digital data traveling through an Ethernet cable. Such a propagated signal may take any of a variety of forms, including, but not limited to, electro-magnetic signals, optical pulses, modulation of a carrier signal, or any combination thereof.

Program code embodied on a computer-readable medium may be transmitted using any appropriate medium, including but not limited to wireless communications media, optical fiber cable, electrically conductive cable, radio-frequency or infrared electromagnetic transmission, etc., or any suitable combination of the foregoing.

Computer program code for carrying out operations for aspects of the present invention may be written in any combination of one or more programming languages, including, but not limited to programming languages like Java, Smalltalk, and C++, and one or more scripting languages, including, but not limited to, scripting languages like JavaScript, Perl, and PHP. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN), a wide area network (WAN), an intranet, an extranet, or an enterprise network that may comprise combinations of LANs, WANs, intranets, and extranets, or the connection may be made to an external computer (for example, through the Internet using an Internet Service Provider).

Aspects of the present invention are described above and below with reference to flowchart illustrations and/or block diagrams of methods, apparatus (systems) and computer program products according to embodiments of the present invention. It will be understood that each block of the flowchart illustrations, block diagrams, and combinations of blocks in the flowchart illustrations and/or block diagrams of FIGS. 1-4 can be implemented by computer program instructions. These computer program instructions may be provided to a processor of a general purpose computer, special purpose computer, or other programmable data-processing apparatus to produce a machine, such that the instructions, which execute via the processor of the computer or other programmable data-processing apparatus, create means for implementing the functions/acts specified in the flowchart and/or block diagram block or blocks.

These computer program instructions may also be stored in a computer-readable medium that can direct a computer, other programmable data-processing apparatus, or other devices to function in a particular manner, such that the instructions stored in the computer-readable medium produce an article of manufacture, including instructions that implement the function/act specified in the flowchart and/or block diagram block or blocks.

The computer program instructions may also be loaded onto a computer, other programmable data-processing apparatus, or other devices to cause a series of operational steps to be performed on the computer, other programmable apparatus, or other devices to produce a computer-implemented process such that the instructions that execute on the computer or other programmable apparatus provide processes for implementing the functions/acts specified in the flowchart and/or block diagram block or blocks.

The flowchart illustrations and/or block diagrams FIGS. 1-4 illustrate the architecture, functionality, and operation of possible implementations of systems, methods and computer program products according to various embodiments of the present invention. In this regard, each block in the flowchart or block diagrams may represent a module, segment, or portion of code, wherein the module, segment, or portion of code comprises one or more executable instructions for implementing one or more specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special-purpose hardware-based systems that perform the specified functions or acts, or combinations of special-purpose hardware and computer instructions.

In FIG. 1, computer system 101 comprises a processor 103 coupled through one or more I/O Interfaces 109 to one or more hardware data storage devices 111 and one or more I/O devices 113 and 115.

Hardware data storage devices 111 may include, but are not limited to, magnetic tape drives, fixed or removable hard disks, optical discs, storage-equipped mobile devices, and solid-state random-access or read-only storage devices. I/O devices may comprise, but are not limited to: input devices 113, such as keyboards, scanners, handheld telecommunications devices, touch-sensitive displays, tablets, biometric readers, joysticks, trackballs, or computer mice; and output devices 115, which may comprise, but are not limited to printers, plotters, tablets, mobile telephones, displays, or sound-producing devices. Data storage devices 111, input devices 113, and output devices 115 may be located either locally or at remote sites from which they are connected to I/O Interface 109 through a network interface.

Processor 103 may also be connected to one or more memory devices 105, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

At least one memory device 105 contains stored computer program code 107, which is a computer program that comprises computer-executable instructions. The stored computer program code includes a program that implements a method for rewarding an advocate in accordance with embodiments of the present invention, and may implement other embodiments described in this specification, including the methods illustrated in FIGS. 1-4. The data storage devices 111 may store the computer program code 107. Computer program code 107 stored in the storage devices 111 is configured to be executed by processor 103 via the memory devices 105. Processor 103 executes the stored computer program code 107.

Thus the present invention discloses a process for supporting computer infrastructure, integrating, hosting, maintaining, and deploying computer-readable code into the computer system 101, wherein the code in combination with the computer system 101 is capable of performing a method for rewarding an advocate.

Any of the components of the present invention could be created, integrated, hosted, maintained, deployed, managed, serviced, supported, etc. by a service provider who offers to facilitate a method for rewarding an advocate. Thus the present invention discloses a process for deploying or integrating computing infrastructure, comprising integrating computer-readable code into the computer system 101, wherein the code in combination with the computer system 101 is capable of performing a method for rewarding an advocate.

One or more data storage units 111 (or one or more additional memory devices not shown in FIG. 1) may be used as a computer-readable hardware storage device having a computer-readable program embodied therein and/or having other data stored therein, wherein the computer-readable program comprises stored computer program code 107. Generally, a computer program product (or, alternatively, an article of manufacture) of computer system 101 may comprise said computer-readable hardware storage device.

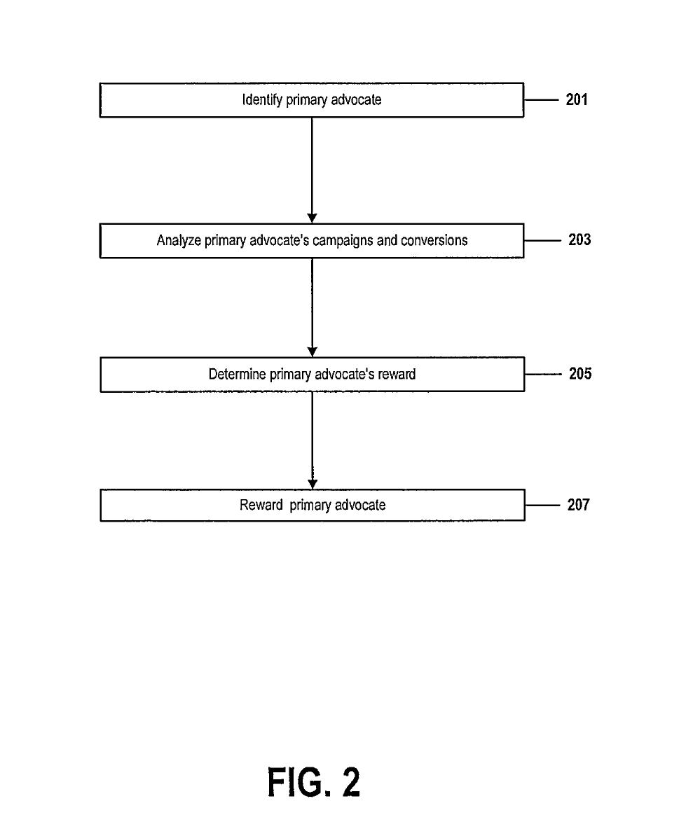

FIG. 2 is a flowchart that overviews embodiments of the present invention that automatically reward or incentivize an advocate of a company's product or service of interest. FIG. 2 comprises steps 201-207.

Step 201 locates and identifies a potentially influencing entity as a “primary advocate” who has advocated, or who is likely to, advocate a product or service of interest. This identification may be performed in a variety of ways well-known to those skilled in the art of online marketing or analytics. Here, a “potentially influencing entity” may be a single person, a group of persons, or an other potentially influencing entity, such as a business or consortium.

A primary advocate's advocacy may take many forms. A primary advocate may, for example, be identified as a function of the primary advocate's current, previous, or ongoing use of keywords associated with the product or service of interest. This function may be related to parameters that may include, but are not limited to: a cumulative number of times that the primary advocate has used one or more of the keywords; a number of times that the primary advocate uses the one or more of the keywords during an identified period of time; a proportion of the primary advocate's activities or expressions of opinion that are related to advocacy, related to the one or more of the keywords, or related to a particular topic, industry, or field of interest; or a frequency with which the primary advocate uses the one or more of the keywords during a period of time.

Other types of functions, techniques, and procedures known to those skilled in the art may be used to locate or identify the primary advocate. A primary advocate may, for example, be located or identified as a function of the primary advocate's: degree of online or offline visibility; level of online or offline activity; online or offline reputation, tokens of recognition, or prestige among members of a community; history of activities related to other online or offline advocacies or expressions of opinion related to other online or offline advocacies; number of online users who have associated themselves with or who otherwise identify with the primary advocate; effectiveness of the primary advocate's prior advocacies, measured by parameters that may include, but are not limited to, a number of prior conversions, amount of exerted influence, or time duration of exerted influence; consistency of online activities, offline activities, opinions, online expression of opinions, or offline expression of opinions, or predictability of online activities, offline activities, opinions, online expression of opinions, or offline expression of opinions; a relationship with an other influential individual; a relationship with an other potentially influencing entity; or other indicators of influence, willingness to adopt a desirable opinion, usage of certain language or implication of certain subtext; popularity, willingness to advocate, or other desirable characteristics.

In embodiments of the present invention, step 201 may be performed as a function of the tasks of identifying, tracking, and analyzing a “campaign” of a primary advocate, as would otherwise be performed in step 203. In other embodiments, step 201 may be performed as a function of the tasks of identifying, tracking, and analyzing a “conversion” of a primary advocate, wherein the identifying, tracking and analyzing would otherwise be performed in step 203.

In some embodiments, step 201 may be automated and may be implemented as a computerized method executed by a processor of a computer system. In some embodiments, step 201 may be implemented under partial or complete control of an administrator, system user, or other computer program.

In some embodiments, step 201 may be performed after step 203. In such embodiments, a potentially influencing entity is identified as a primary advocate as a function of identification, tracking, and analyzing performed by step 203.

Step 203 identifies, tracks, and analyzes a set of campaigns of the primary advocate and a set of conversions of the primary advocate. As described above, a primary advocate's “campaign” may refer to an activity or to an expression of opinion related to the primary advocate's act of advocating an identified product or service. In some embodiments, an activity or expression of opinion may be identified as a campaign only if the activity or expression satisfies a condition, such as comprising a minimum number of keywords associated with a product or service of interest.

A campaign may comprise almost any type of online or offline advocacy, such as an endorsement on a social-media site, a favorable comment posted on a blog, a review in a printed newspaper or magazine, or a mere reporting of product information by means of an online or offline electronic medium.

As described above, a “conversion” of the primary advocate refers to a campaign of a converted advocate, wherein the converted advocate is distinct from the primary advocate, and wherein the converted advocate's campaign comprises an act of advocating a product or service of interest in response to, as a full or partial result of the influence of, or as an other function of, the primary advocate's campaign.

A converted advocate's advocating may be measured as a function of many other parameters that may include, but are not limited to: the converted advocate's subscription to, rental of, or purchase of a product or service; the converted advocate's accumulation or retention of a “cookie” file from a Web site; or the converted advocate's online clickthroughs, site navigation, or other online behavior.

In some embodiments, the primary advocate's campaign and the converted advocate's campaign advocate at least one common product or service of interest. In all cases, an advocated product or service of the primary advocate's campaign has some relation to an advocated product or service of the converted advocate's campaign.

The converted advocate will always be a direct or indirect recipient of an advocating communication comprised by a campaign of the primary advocate. If the primary advocate's campaign was communicated through an offline or nonelectronic medium, an indirect communication in an electronic or online medium that references or otherwise identifies the primary advocate's campaign or the information comprised by that campaign may allow step 203 to identify, track, or analyze the primary advocate's campaign, or may allow the primary advocate's campaign to influence and convert the converted advocate.

In some embodiments, a campaign may comprise a multi-generational iterative activity that begins with a primary advocate's initial act of advocating a product or service of interest, continues with a first generation of converted advocates who each advocate the same product or service of interest in response to the primary advocate's advocacy, continues further through successive generations of converted advocates who continue to spawn additional generations of converted advocates, and ends with the spawning of the last converted advocate's advocacy. At each step, a campaign may include other functions, such as identifying, tracking, or analyzing each advocate's activities, expressions of opinion, campaigns, or conversions; or rewarding each advocate as a function of that advocate's conversions, campaigns, or other activities or expressions of opinion.

The primary advocate's campaigns and conversions are identified, tracked, or analyzed by step 203 through any means known to those skilled in the relevant arts. These means may comprise, but are not limited to, techniques, methods, or models of: text analytics; semantic analytics; other types of analytics; text-mining; data mining; online search; online semantic search; database lookup; cookie-tracking; autonomous or semiautonomous Web crawlers or spiders; or content scraping. This identifying, tracking, or analyzing may be performed continuously in real time, updated at predetermined or triggered times, updated ad hoc by a human user, or updated in response to a request by an extrinsic entity. Manual identifying, tracking, and analyzing mechanisms may be used, either alone or in combination with automated or electronic means.

In some embodiments, a potentially influencing entity may self-identify or self-nominate itself to be a primary advocate through an offline or online communications mechanism, and this self-identification or self-nomination may be performed in response to a general or specific call for advocates.

In addition to tracking the primary advocate's campaigns and conversions, step 203 may use techniques, methods, or models known to those skilled in the art of analytics, statistical analysis, data-mining, or other areas of mathematics or computer science to analyze, transform, organize, or otherwise process information comprised by the primary advocate's tracked campaigns and conversions. This processing may be intended to characterize aspects of the primary advocate's online presence, status, opinions, tendencies, skills or abilities, or behavior that may be related to determining an appropriate manner, type, or quantity of reward or incentive in step 205.

Step 205 uses information produced by steps 201 and 203 to determine a manner, type, or quantity of a reward or incentive provided to the primary advocate.

The details of this determining are implementation-dependent and may comprise, or be functions of, techniques, methods, or models known to those skilled in the art of analytics, statistical analysis, data-mining, business planning, or other areas of mathematics, management science, analytics, or computer science.

In some embodiments, this determining may comprise a function of a characteristic of a campaign or conversion of the primary advocate, a function of a conversion of the primary advocate, or a function of a parameter related to the identification of the primary advocate in step 201. Such a parameter might be related to one or more keywords identified by step 201 as being associated with a product or service of interest.

In some embodiments, such an association may associate keywords to a product or service, to each other, or to data structures that comprise one or more of the keywords. Such an association may associate keywords generically or as a function of multiple parameters. An embodiment might, for example, consider an advocate's frequent expressions of opinion about a first brand of footwear when determining a manner, type, or quantity of a reward or incentive provided to the advocate by a distributor of a either the first brand of footwear or a second brand of footwear, regardless of whether the advocate's expressions of opinion about the first brand are positive or negative. In some embodiments, a negative expression of opinion about the first brand may increase the value of a reward awarded as a function of a positive advocacy about the second brand.

In some embodiments, a positive expression of opinion about the first brand may increase or decrease a value or other characteristic of a reward awarded as a function of a subsequent favorable advocacy about the second brand. In some embodiments, a negative expression of opinion about the first brand may increase or decrease a value or other characteristic of a reward awarded as a function of a subsequent favorable advocacy about the second brand.

In some embodiments, a human or electronic administrator or a campaign manager might add or delete keywords, functions comprised by the determining, data structures that organize keywords, or relations between keywords. In certain embodiments, such adding or deleting may be ad hoc, may follow guidelines defined by a method of the embodiment, or may be under a control of the administrator or campaign manager.

A reward or incentive may, for example, be greater in magnitude, be provided more quickly, or may be in a more desirable form if a primary advocate has: used a greater number of the identified keywords in current or prior campaigns; used an identified keyword with greater frequency in current or prior campaigns; used one or more identified keywords a greater total number of times in current or prior campaigns; converted a greater number of recipients in current or prior campaigns; converted a more desirable recipient in a current or prior campaign; or converted a recipient in a current or prior campaign who has in turn converted a greater number of the recipient's own recipients.

In some embodiments, a manner, type, or quantity of a primary advocate's reward or incentive may be a function of the primary advocate's “conversion power,” wherein the primary advocate's conversion power is a function of factors that may comprise, but are not limited to, a number of the primary advocate's converted advocates that, as a function of an advocacy of the primary advocate: advocate a product or service of interest; subscribe to, purchase, rent, or lease a product or service of interest; or contribute to some other desired activity or expression of opinion related to a product or service of interest.

In some embodiments, a primary advocate's conversion power may be a function of a number of converted advocates' campaigns or a number of converted advocates' advocacies.

In some embodiments, a manner, type, or quantity of a primary advocate's reward or incentive may be a function of the primary advocate's “influence,” wherein, in this context, the primary advocate's influence is a function of an online or offline presence of the primary advocate, and wherein the online or offline presence may be a function of factors that may comprise, but are not limited to: a number, frequency, or venue of online postings made by the primary advocate; a number of third-party entities that identify themselves online with or associate themselves online with the primary advocate; or a number of times that a third-party entity refers online to the primary advocate or cites online, refers online to, or links online to an act or communication of the primary advocate.

In some embodiments, a manner, type, or quantity of a primary advocate's reward or incentive may be a function of a characteristic of a converted recipient. Such a characteristic may comprise, but is not limited to, a conversion power or an influence of the converted recipient, a campaign of the converted recipient, or a conversion of the converted recipient.

A determination of a manner, type, or quantity of the primary advocate's reward may be a function of other factors that comprise, but are not limited to: a goal of a business that benefits from an advocacy of a service or product of interest; limitations of a communications medium or data-related technology; ethical, moral, or cultural standards or norms; or an other extrinsic factor, such as a product-launch date, an adoption of a new industry standard or protocol, a factor related to a business cycle, a development of a new technology or a new electronic or non-electronic medium, a change in customer demographics, or a financial or political event that affects a relevant market.

In one example, a primary advocate may be automatically rewarded by small monetary transfers to an online financial account associated with the primary advocate. Each such transfer might be automatically triggered when a recipient is converted by the primary advocate's endorsing online or offline a product announcement originally posted by a sponsoring business. This conversion might comprise the recipient reposting the primary advocate's endorsement in a desired electronic venue. In some embodiments, the automatic triggering may be used to implement bulk payments to larger numbers of advocates.

In another embodiment, a primary advocate may be rewarded by being recognized on a popular “technology genius” Web site maintained by a rewarding entity that desires to promote a new service. This recognition incentive might be triggered when a characteristic of the primary advocate's campaign for the new service attains a threshold value. This threshold might be a function of: a number of times that the primary advocate's campaigns mention a keyword associated with the identified technology; a number of conversions that occur in response to the primary advocate's campaigns; an aggregate amount of influence held by recipients that are converted as a result of the primary advocate's campaigns; or a number of indirect conversions that result from campaigns initiated by converted advocates who had been directly converted by the primary advocate's campaigns.

In yet another embodiment, a primary advocate who meets certain online-presence qualifications might be allowed into a company's exclusive beta-testing program as a reward for demonstrating commitment to the company's product line. Here, an online-presence qualification might comprise demonstrating a certain level of influence or visibility, which may be measured as a function of parameters that include a number of third-party online citations of the primary advocate's postings or a number of third-party hyperlinks to the primary advocate's personal blog. In some cases, an online presence may be an indirect result of offline activities, such as hosting a speaking tour. The primary advocate might demonstrate an appropriate commitment to the company's product line by mentioning certain identified keywords on the primary advocate's blog with a certain frequency over a specified period of time, wherein those mentioned keywords result in a certain number of conversions. In some embodiments, the term “keywords” may comprise verbal and nonverbal content including, but not limited to audio recordings, video or movie clips, photographic images, animations, presentations, or graphics.

Many other determining criteria are possible, and a choice of such criteria may be based on implementation-specific design goals and constraints. But a feature common to all embodiments of the present invention is that the determining of step 205 be a function of at least one component of step 201's or step 203's identifying, tracking, or analyzing.

Step 207 provides to the primary advocate a reward or incentive determined by step 205. This providing may be performed through any means known to those skilled in the relevant arts. Providing may be accomplished through a means that comprises, but is not limited to: automatic or manual transfer to an online or offline financial account; alteration of a Web site, blog, or other Internet entity; an electronic message, broadcast, email, text message, postal mailing, or other transmission of information through an online or an offline medium; or a revision of a status, authorization, or other characteristic of the primary advocate.

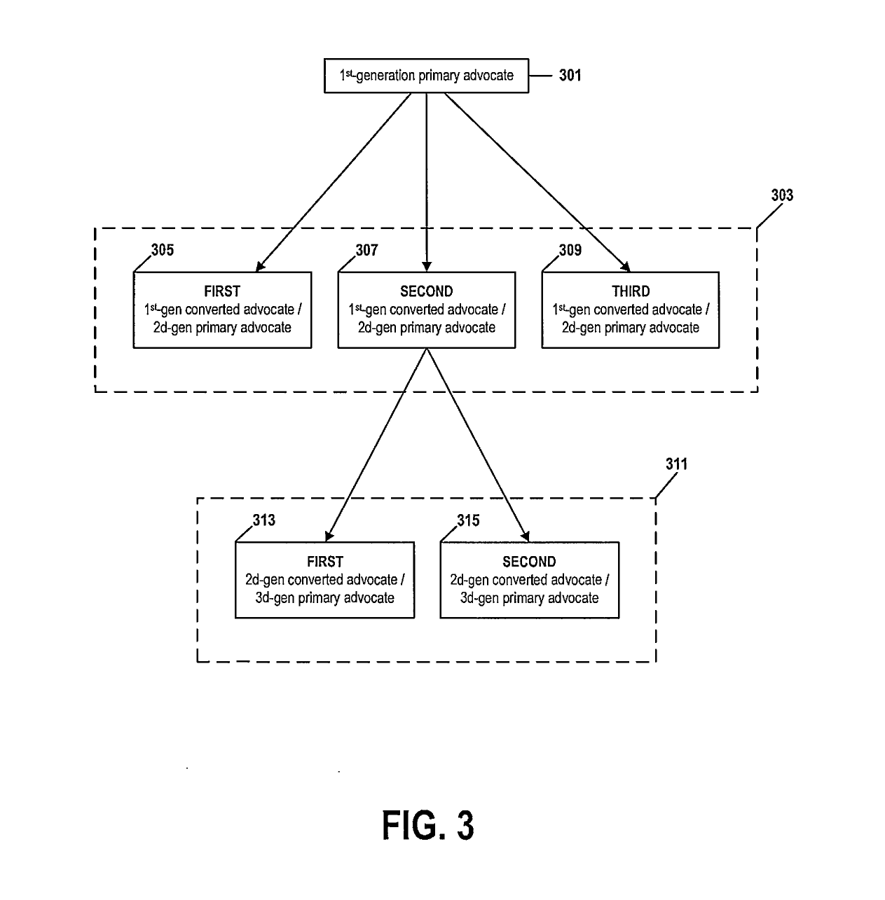

FIG. 3 shows an example of a multi-generational advocacy, wherein advocates may be rewarded by iterative applications of the embodiments of FIG. 2. FIG. 3 comprises items 301-315.

In such a multi-generational embodiment, a first-generation primary advocate may convert one or more first-generation converted advocates, each of which may in turn convert one or more second-generation converted advocates. These second-generation converted advocates may then spawn further generations of converted advocates. In such a multi-generational embodiment, the method of FIG. 2 may be applied iteratively to determine a manner, type, or quantity of reward for each advocate at each generation.

Item 301 shows a first-generation primary advocate, as identified by the method of FIG. 2, step 201, whose advocacy communicates information to a first, a second, and a third recipient. Here, the first-generation primary advocate's communicating may convert the first recipient 305 into a first first-generation converted advocate, the second recipient 307 into a second first-generation converted advocate, or the third recipient 309 into a third first-generation converted advocate.

The method of FIG. 2 may be further applied to each advocate of this first generation of converted advocates 303 by treating it as a second-generation primary advocate. In such a case, the first recipient 305 may be deemed to be both the first first-generation converted advocate and a first second-generation primary advocate, the second recipient 307 may be deemed to be both the second first-generation converted advocate and a second second-generation primary advocate, and the third recipient 309 may be deemed to be both the third first-generation converted advocate and a third second-generation primary advocate.

In this multi-generational embodiment, the second first-generation converted advocate 307 might then spawn a second generation of converted advocates through an advocacy that converts two second-generation recipients 313-315 into a first second-generation converted advocate 313 and a second second-generation converted advocate 315. The method of FIG. 2 may be further applied to this second generation of converted advocates 311 by treating them as a third generation of primary advocates. In such a case, the first second-generation converted advocate 313 may be deemed to be a first third-generation primary advocate and the second second-generation converted advocate 315 may be deemed to be a second third-generation primary advocate.

In other words, the method of FIG. 2 may be used to determine a manner, type, or quantity of reward for an n^{th}-generation converted applicant by applying the method to that converted applicant as though that converted applicant is an (n+1)^{st}-generation primary advocate.

This procedure may be repeated through an indefinite number of generations of advocacies and conversions, applying the method of FIG. 2 to each converted advocate, regardless of generation, as though the converted advocate were a primary advocate, and then again applying the method of FIG. 2 to a converted advocate of the next generation as though the converted advocate of the next generation was a primary advocate. In the example of FIG. 3, the method of FIG. 2 might determine a manner, type, or quantity of reward provided to each advocate by applying the method six times, to the advocates represented by items 301, 305, 307, 309, 313, and 315. If automated, the method may be used to automatically reward many generations of converted advocates influenced directly or indirectly by a single influencing primary advocate's activity or expression of opinion.

In one iteration, for example, the method of FIG. 2 might determine a manner, type, or quantity of reward provided to first-generation primary advocate 301 as a function of the first-generation primary advocate's conversions of the three first-generation converted advocates 305-309. The next iteration might determine a manner, type, or quantity of reward provided to advocate 307 (treating advocate 307 as a second-generation primary advocate) as a function of conversions of advocate 307's two second-generation converted advocates 313 and 315.

In a multi-generational embodiment like that of FIG. 3, a set of advocates may be represented as a directed graph or a tree, wherein a root of the graph or of the tree represents a first-generation primary advocate 301, and wherein a parent node and the parent node's related child node respectively represent a primary advocate and a converted advocate, wherein the converted advocate was converted by an advocacy of the primary advocate.

As described above, embodiments of the method of FIG. 2 may determine a manner, type, or quantity of reward or incentive provided to the primary advocate represented by the parent node of such a graph or tree, wherein the determining may be a function of characteristics of the converted advocate represented by the corresponding child node.

In some embodiments, the method of FIG. 2 may also determine a manner, type, or quantity of reward or incentive provided to the advocate represented by the child node (treating that child-node advocate as a next-generation primary advocate), wherein the determining may be a function of characteristics of the advocate represented by parent node. In such embodiments, characteristics of the advocate represented by the parent node may in part determine the manner, type, or quantity of reward provided to the corresponding child node.

In FIG. 3, for example, the second first-generation converted advocate 307 is converted by the first-generation primary advocate 301. As described above, the method of FIG. 2 may determine a manner, type, or quantity of reward provided to the first-generation primary advocate 301 as a function of characteristics, opinions, or behavior of first-generation converted advocate 307. But in some embodiments, the converse may be true: a manner, type, or quantity of reward provided to advocate 307—treated as a second-generation primary advocate—may be a function of characteristics, opinions, or behavior of first-generation primary advocate 301.

This latter condition might occur when, for example, second-generation primary advocate 307 publishes a product review on a Web site, social-media Web site, or social-media service like Facebook, LinkedIn, Pinterest.com, YouTube, or Google+, or broadcasts the review to mobile devices as a Twitter “tweet.” In such a case, an embodiment of the present invention might deem the published review to be worthy of greater reward if the review echoes conclusions made by a more influential primary advocate 301. In this case, a characteristic of a parent advocate would thus affect a manner, type, or quantity of a reward or incentive provided to a child advocate, even if the method otherwise treats the child as a primary advocate.

In some embodiments, a first reward or incentive provided to a primary advocate may be determined by a function different than a function that determines a second reward or incentive provided to a converted advocate of the primary advocate. In embodiments wherein two converted advocates are converted by a same primary advocate, a first reward or incentive provided to the first converted advocate may be determined by a function different than a function that determines a second reward or incentive provided to the second converted advocate.

In some embodiments, a manner, type, or quantity of reward provided to an advocate may be a function of characteristics, opinions, or behavior of a plurality of other advocates, wherein the plurality of other advocates comprises advocates that occupy both parent and child generations of advocates. In some cases, the plurality of advocates may occupy noncontiguous generations. In an extension of FIG. 3, for example, that comprises ten generations of converted advocates represented as a ten-level tree, a manner, type, or quantity of reward or incentive provided to an advocate at level six may be a function of characteristics, opinions, or behavior of advocates scattered throughout levels one, two, five, seven, nine, and ten. In some embodiments, an advocate of these scattered advocates may not be directly related to the advocate at level six through a direct primary/converted-advocate relationship.

What is claimed is:

1. A method for rewarding an online advocate, the method comprising:
a processor of a computer system identifying an entity as a primary advocate, wherein the identifying is a function of an advocacy of the entity, and wherein the advocacy comprises the entity's act of advocating an advocated product or service;
the processor automatically tracking a set of the primary advocate's conversions, wherein a tracked conversion of the set of the primary advocate's conversions comprises a first converted advocate's advocacy, and wherein the first converted advocate's advocacy comprises the first converted advocate's act of advocating the advocated product or service as a function of the primary advocate's advocacy;
the processor determining a reward for the primary advocate as a function of the identification and as a further function of the tracked conversion.

2. The method of claim 1, wherein the primary advocate's advocacy further comprises a keyword associated with the advocated product or service, and wherein the identifying is a further function of a frequency of usage of the keyword in the primary advocate's advocacy.

3. The method of claim 1, wherein the primary advocate's advocacy further comprises a keyword associated with the advocated product or service, and wherein the identifying is a further function of a total number of times that the keyword is used in the primary advocate's advocacy.

4. The method of claim 1, wherein the determining is a further function of a conversion power of the primary advocate, and wherein the conversion power is a function of a number of converted advocates that advocate the advocated product or service as a function of the primary advocate's advocacy.

5. The method of claim 1, wherein the determining is a further function of an influence of the primary advocate, wherein the primary advocate's influence is a function of an online presence of the primary advocate, and wherein the primary advocate's online presence is selected from a group comprising:
a number of online postings made by the primary advocate;
a number of third-party entities that associate themselves online with the primary advocate; and
a number of times that a third-party entity refers online to the primary advocate or refers online to an act or communication of the primary advocate.

6. The method of claim 1, further comprising:
the processor identifying the first converted advocate as a primary advocate, wherein the identifying is a function of the first converted advocate's advocacy; and
the processor repeating the steps of tracking and determining.

7. A computer program product, comprising a computer-readable hardware storage device having a computer-readable program code stored therein, said program code configured to be executed by a processor of a computer system to implement a method comprising:
the processor identifying an entity as a primary advocate, wherein the identifying is a function of an advocacy of the entity, and wherein the advocacy comprises the entity's act of advocating an advocated product or service;
the processor automatically tracking a set of the primary advocate's conversions, wherein a tracked conversion of the set of the primary advocate's conversions comprises a first converted advocate's advocacy, and wherein the first converted advocate's advocacy comprises the first converted advocate's act of advocating the advocated product or service as a function of the primary advocate's advocacy;
the processor determining a reward for the primary advocate as a function of the identification and as a further function of the tracked conversion.

8. The method of claim 7, wherein the primary advocate's advocacy further comprises a keyword associated with the advocated product or service, and wherein the identifying is a further function of a frequency of usage of the keyword in the primary advocate's advocacy.

9. The method of claim 7, wherein the primary advocate's advocacy further comprises a keyword associated with the advocated product or service, and wherein the identifying is a further function of a total number of times that the keyword is used in the primary advocate's advocacy.

10. The method of claim 7, wherein the determining is a further function of a conversion power of the primary advocate, and wherein the conversion power is a function of a number of converted advocates that advocate the advocated product or service as a function of the primary advocate's advocacy.

11. The method of claim 7, wherein the determining is a further function of an influence of the primary advocate, wherein the primary advocate's influence is a function of an online presence of the primary advocate, and wherein the primary advocate's online presence is selected from a group comprising:
a number of online postings made by the primary advocate;
a number of third-party entities that associate themselves online with the primary advocate; and
a number of times that a third-party entity refers online to the primary advocate or refers online to an act or communication of the primary advocate.

12. The method of claim 7, further comprising:
the processor identifying the first converted advocate as a primary advocate, wherein the identifying is a function of the first converted advocate's advocacy; and
the processor repeating the steps of tracking and determining.

13. A computer system comprising a processor, a memory coupled to said processor, and a computer-readable hardware storage device coupled to said processor, said storage device containing program code configured to be run by said processor via the memory to implement a method for rewarding an advocate, said method comprising:
the processor identifying an entity as a primary advocate, wherein the identifying is a function of an advocacy of the entity, and wherein the advocacy comprises the entity's act of advocating an advocated product or service;
the processor automatically tracking a set of the primary advocate's conversions, wherein a tracked conversion of the set of the primary advocate's conversions comprises a first converted advocate's advocacy, and wherein the first converted advocate's advocacy comprises the first converted advocate's act of advocating the advocated product or service as a function of the primary advocate's advocacy;
the processor determining a reward for the primary advocate as a function of the identification and as a further function of the tracked conversion.

14. The method of claim 13, wherein the primary advocate's advocacy further comprises a keyword associated with the advocated product or service, and wherein the identifying is a further function of a frequency of usage of the keyword in the primary advocate's advocacy.

15. The method of claim 13, wherein the primary advocate's advocacy further comprises a keyword associated with the advocated product or service, and wherein the identifying is a further function of a total number of times that the keyword is used in the primary advocate's advocacy.

16. The method of claim 13, wherein the determining is a further function of a conversion power of the primary advocate, and wherein the conversion power is a function of a number of converted advocates that advocate the advocated product or service as a function of the primary advocate's advocacy.

17. The method of claim 13, wherein the determining is a further function of an influence of the primary advocate, wherein the primary advocate's influence is a function of an online presence of the primary advocate, and wherein the primary advocate's online presence is selected from a group comprising:
a number of online postings made by the primary advocate;
a number of third-party entities that associate themselves online with the primary advocate; and
a number of times that a third-party entity refers online to the primary advocate or refers online to an act or communication of the primary advocate.

18. The method of claim 13, further comprising:
the processor identifying the first converted advocate as a primary advocate, wherein the identifying is a function of the first converted advocate's advocacy; and
the processor repeating the steps of tracking and determining.
